(19) United States
(12) Patent Application Publication
(10) Pub. No.: US 2009/0033246 A1
(43) Pub. Date: Feb. 5, 2009

(54) LIGHT EMITTING DIODE LAMP

(75) Inventors: Wen-Kuei Tsai, Taipei County (TW); Chun-Chien Wang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: TOPCO TECHNOLOGIES CORP., Taipei City (TW)

(21) Appl. No.: 11/839,498

(22) Filed: Aug. 15, 2007

(30) Foreign Application Priority Data
Jul. 30, 2007 (TW) 96212444

(51) Int. Cl. H05B 37/02

(52) U.S. Cl. 315/297

(57) ABSTRACT

A light emitting diode (LED) lamp includes a lamp body, a current control circuit, and an LED array disposed inside the lamp body. The LED array is electrically connected to the current control circuit. The LED array includes a carrier, a plurality of first LEDs disposed on the carrier for emitting a first light, and a plurality of second LEDs disposed on the carrier for emitting a second light. The first light and the second light have a same color but different color temperatures. The above-mentioned LED lamp provides lights with different color temperatures.

### CROSS-REFERENCE TO RELATED APPLICATION

This application claims the priority benefit of Taiwan application serial no. 96212444, filed Jul. 30, 2007. All disclosure of the Taiwan application is incorporated herein by reference.

### BACKGROUND OF THE INVENTION

1. Field of the Invention

The present invention relates to an illumination device. More particularly, the present invention relates to a light emitting diode (LED) lamp.

2. Description of Related Art

LEDs are semiconductor devices. The light emitting chips are mainly made of a compound semiconductor material containing III-V group chemical elements, for example, GaP, GaAs, and the like, and function on the principle of converting electric energy to light. That is to say, the compound semiconductor is powered to release excessive energy through the combination of electrons and holes, so as to emit photon (light). The LED can emit light without being heated or does not discharge to emit light. Therefore, the lifespan of the LED is up to 100,000 hours, and an idling time is not required. In addition, the LED has advantages of quick response speed (approximately 10⁻⁹ seconds), small volume, power-saving, low pollution, high reliability, and ease mass production. Thus, the LEDs have been intensively used in many fields, for example, light source and illumination device in large-scale bulletin boards, traffic lights, cellular phones, scanners, fax machines, etc.

Currently, the light emitting brightness and efficiency of the LEDs are continuously improved, and meanwhile the white LEDs are successfully put into mass production, so the LED have been gradually used for illumination purpose, and LED lamps (e.g. bulbs, street lamps, flash lights, etc.) have been developed. However, the light emitted by no matter the common energy-saving bulbs or the newly developed LEDs has a constant color temperature, and the light with another color temperature cannot be obtained unless the bulbs is replaced, which causes inconvenience to users. Generally speaking, a white light lamp with high color temperature is suitable for the working situation or the situation where the color of an object is required to be recognized accurately. A white light lamp with low color temperature is suitable for the living environment to create a harmonious atmosphere. Therefore, lights with different color temperatures are required for different situations and different affairs, and the current LED bulbs with constant color temperature cannot meet this requirement.

### SUMMARY OF THE INVENTION

Accordingly, the present invention is directed to provide an LED lamp, capable of providing lights with different color temperatures.

Accordingly, the present invention provides an LED lamp, including a lamp body, a current control circuit, and an LED array disposed inside the lamp body. The LED array is electrically connected to the current control circuit. The LED array includes a carrier, a plurality of first LEDs disposed on the carrier for emitting a first light, and a plurality of second LEDs disposed on the carrier for emitting a second light. The first light and the second light have a same color but different color temperatures.

In an embodiment of the present invention, the lamp body includes an electrode portion and a lampshade connected to the electrode portion, wherein the LED array is disposed inside the lampshade and is electrically connected to the electrode portion.

In an embodiment of the present invention, the current control circuit is disposed inside the lamp body.

In an embodiment of the present invention, the current control circuit is disposed outside the lamp body.

In an embodiment of the present invention, the carrier includes a metal core printed circuit board (MCPCB).

In an embodiment of the present invention, the first LEDs include surface mount device (SMD) type packages or pin through hole (PTH) type packages.

In an embodiment of the present invention, the second LEDs include SMD type packages or PTH type packages.

In an embodiment of the present invention, the first light and the second light include a white light. In addition, a color temperature of the first light is between about 2200 K and about 9000 K, and a color temperature of the second light is between about 2200 K and about 9000 K.

In an embodiment of the present invention, the number of the first LEDs is same as that of the second LEDs.

In an embodiment of the present invention, the number of the first LEDs is different from that of the second LEDs.

The present invention may use a current control circuit built in the lamp body or an external current control circuit to control a lighting state of the LED array, so the LED lamp of the present invention can provide various lights with different color temperatures to meet the requirements of the user.

The present invention provides an LED lamp, including a current control circuit and a plurality of LEDs with different color temperatures. The current control circuit may light up the plurality of first LEDs only to emit the first light with a first color temperature. The current control circuit may also light up the plurality of second LEDs only to emit the second light with a second color temperature. Therefore, the lights with various color temperatures may be provided according to different requirements and situations. According to the spirit of the present invention, the LED lamp of the present invention may further include an LED with more than three color temperatures, so as to provide the lights with more color temperatures.

In an embodiment of the present invention, the current control circuit may further light up a part of the plurality of first LEDs and a part of the plurality of second LEDs at the same time. The color temperature is adjusted by adjusting the relative numbers of the lighted first LED and second LED. To sum up, the current control circuit may be used to control the lighting up of 0 to all the first LEDs and 0 to all the second LEDs, thereby obtaining the light with various color temperatures and brightness.

The LED lamp of the present invention includes a current control circuit and a plurality of LEDs with different color temperatures. Under the control of the current control circuit, the same LED lamp may be used to provide the light with various color temperatures, so as to meet different requirements and situations.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of an LED lamp according to an embodiment of the present invention.

### DESCRIPTION OF EMBODIMENTS

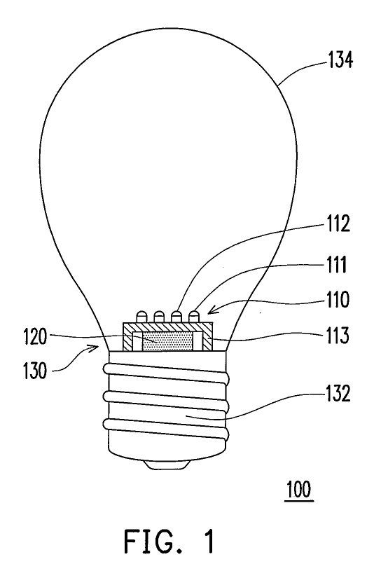

FIG. 1 is a schematic cross-sectional view of an LED lamp according to an embodiment of the present invention. Referring to FIG. 1, the LED lamp 100 of present embodiment includes a lamp body 130, a current control circuit 120, and an LED array 110 disposed inside the lamp body 130. It is known from FIG. 1 that the LED array 110 is electrically connected with the current control circuit 120, and the LED array 110 includes a carrier 113, a plurality of first LEDs 111, and a plurality of second LEDs 112. The first LEDs 111 are disposed on the carrier 113 for emitting a first light. The second LEDs 112 are similarly disposed on the carrier 113 for emitting a second light. It should be noted that the first light and the second light emitted by the first LEDs 111 and the second LEDs 112 have substantially the same color but different color temperatures.

The LED lamp 100 of the present invention may be lamps of different types, for example, light bulbs, spot lights, etc. For example, the lamp body 130 of the LED bulb is composed of an electrode portion 132 and a lampshade 134. It is known from FIG. 1 that the lampshade 134 is connected to the electrode portion 132. The LED array 120 is disposed inside the lampshade 134, and is electrically connected to the electrode portion 132. Generally speaking, mostly the lampshade 134 is fabricated by frosted glass or plastic material that allows light to pass through, and may diffuse light uniformly, so as to provide the glareless soft light. In addition, the profile of the electrode portion 132 is required to match a bulb socket, so as to conduct power to the bulb for the LED array 110 to use.

In view of the above, the current control circuit 120 may be disposed inside the lamp body 134 or outside the lamp body 134. In other words, the current control circuit 120 may be integrated on the LED array 110 inside the lamp body 134, or integrated in other loops or switches outside the lamp body 134. For example, if the current control circuit 120 is integrated on the LED array 110 inside the lamp body 134, the current control circuit 120 may be fabricated into an integrated circuit (IC). Then, the IC having a current modulation function is soldered on the carrier 113, so as to make the current control circuit 120 electrically connect to the carrier 113, thereby modulating the driving current received by the first LEDs 111 and the second LEDs 112. In addition, the current control circuit 120 may also be directly integrated in lines inside the carrier 113.

It should be noted that if the current control circuit 120 is integrated inside the lamp body 134, it may be introduced into the market of illumination device quickly. The user may use the switch to change the color temperature of the LED lamp 100 successfully without changing a power distribution system in the living environment.

In the LED array 110 of present embodiment, the carrier 113 is, for example, a MCPCB or another carrier having good thermal conductivity. The first LEDs 111 and the second LEDs 112 are, for example, SMD type packages or PTH type packages.

For example, the first LEDs 111 and the second LEDs 112 may be white LEDs, but the lights emitted by the first and second LEDs 111, 112 have different color temperatures. In a preferred embodiment, the color temperature of the first light emitted by the first LEDs 111 is, for example, between about 2200 K and about 9000 K, and the color temperature of the second light emitted by the second LEDs 112 is, for example, between about 2200 K and about 9000 K.

In present embodiment, the number of the first LEDs 111 and the number of the second LEDs 112 may be adjusted appropriately according to actual requirements. In detail, when the number of the first LEDs 111 and the number of the second LEDs 112 are the same, all the first LEDs 111 may be lighted to make the LED lamp 100 provide the color temperature of the first lights, or all the second LEDs 112 may be lighted to make the LED lamp 100 provide the color temperature of the second lights, or all the first LEDs 111 and the second LEDs 112 are lighted to make the LED lamp 100 provide a third color temperature between the above two color temperatures. Definitely, in order to make the modulation of the color temperature of the LED lamp 100 be more flexible, the proportion of numbers of the first LEDs 111 and the second LEDs 112 in use may be changed. Or, the numbers of the first LEDs 111 and second LEDs 112 to be lighted may be selected respectively, so as to make the LED lamp 100 provide more various color temperatures. In addition, in present embodiment, the amount of input current may be changed to modulate the relative brightness of the first LEDs 111 and the second LEDs 112, thereby obtaining more various color temperatures.

Generally speaking, the LED lamp 100 may be electrically connected to a switch, and the user can use the switch to control the on/off of the LED lamp 100. In present embodiment, the current control circuit 120 in the LED lamp 100 may determine how to drive the LED array 110 according to how many times the switch is flashed by the user.

To sum up, in the present invention, the color temperature of the LED lamp 100 may be switched according to the requirements of the user, so as to meet different requirements of the users, such that the LED lamp 100 is widely accepted by consumers.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A light emitting diode (LED) lamp, comprising:
a lamp body;
a current control circuit;
an LED array disposed inside the lamp body, wherein the LED array is electrically connected to the current control circuit, and the LED array comprises:
a carrier;
a plurality of first LEDs disposed on the carrier, wherein the first LEDs are suitable for emitting a first light; and
a plurality of second LEDs disposed on the carrier, wherein the second LEDs are suitable for emitting a second light, and the first light and the second light have a same color but different color temperatures.

2. The LED lamp as claimed in claim 1, wherein the lamp body comprises:
an electrode portion; and
a lampshade, connected to the electrode portion, wherein the LED array is disposed inside the lampshade and is electrically connected to the electrode portion.

3. The LED lamp as claimed in claim 1, wherein the current control circuit is disposed in the lamp body.

4. The LED lamp as claimed in claim 1, wherein the current control circuit is disposed outside the lamp body.

5. The LED lamp as claimed in claim 1, wherein the carrier comprises a metal core printed circuit board (MCPCB).

6. The LED lamp as claimed in claim 1, wherein the first LEDs comprise surface mount device (SMD) type packages or pin through hole (PTH) type packages.

7. The LED lamp as claimed in claim 1, wherein the second LEDs comprise SMD type packages or PTH type packages.

8. The LED lamp as claimed in claim 1, wherein the first light and the second light comprise white light.

9. The LED lamp as claimed in claim 8, wherein a color temperature of the first light is between about 2200 K and about 9000 K, and a color temperature of the second light is between about 2200 K and about 9000 K.

10. The LED lamp as claimed in claim 1, wherein a number of the first LEDs is the same as that of the second LEDs.

11. The LED lamp as claimed in claim 1, wherein a number of the first LEDs is different from that of the second LEDs.
